(19) United States
(12) Patent Application Publication
(10) Pub. No.: US 2008/0239428 A1
(43) Pub. Date: Oct. 2, 2008

(54) NON-FT PLANE ANGULAR FILTERS

(75) Inventors: BERNARD White BELL, Lafayette, CO (US); KEVIN R. CURTIS, Longmont, CO (US); HUGH J. MASTERSON, Broomfield, CO (US); BRADLEY J. SISSOM, Boulder, CO (US); JAMES P. TUCKER, Boulder, CO (US)

Correspondence Address: JAGTIANI + GUTTAG, 10363-A DEMOCRACY LANE, FAIRFAX, VA, 22030, US

(73) Assignees: INPHASE TECHNOLOGIES, INC., LONGMONT, CO (US); NINTENDO CO., LTD., KYOTO (JP)

(21) Appl. No.: 11/872,051

(22) Filed: Oct. 15, 2007

Related U.S. Application Data
(60) Provisional application No. 60/907,445, filed on Apr. 2, 2007.

(51) Int. Cl. G03H 1/04; G03H 1/22

(52) U.S. Cl. 359/30; 359/32

(57) ABSTRACT

Non-Fourier Transform (FT) plane angular filters and their use in holographic storage systems or devices for angular filtering of a data beam prior to recording holographic data or for angular filtering of a recovered beam prior to detecting the recovered holographic data. The non-FT plane filters may be a macrotube array, an etalon, a multi-layer thin film interference coating on a curved surface, a lenslet array device, a waveguide-like array, or a combination thereof. Also provided are methods for carrying out angular filtering using such filters for data storage and/or data recovery.

### CROSS-REFERENCE TO RELATED APPLICATIONS

This application makes reference to and claims the priority date of the following co-pending U.S. patent application: U.S. Prov. App. No. 60/907,445, entitled “NON-FT PLANE POLYTOPIC FILTERS,” filed Apr. 2, 2007. The entire disclosure and contents of the above provisional application is hereby incorporated by reference.

### STATEMENT OF JOINT RESEARCH AGREEMENT

In compliance with 37 C.F.R. §1.71(g) (1), disclosure is herein made that the claimed invention was made pursuant to a Joint Research Agreement as defined in 35 U.S.C. 103 (c) (3), that was in effect on or before the date the claimed invention was made, and as a result of activities undertaken within the scope of the Joint Research Agreement, by or on the behalf of InPhase Technologies, Inc. and Nintendo Co., Ltd.

### BACKGROUND

1. Field of the Invention

The present invention relates to non-FT plane angular filters and their use in holographic data storage systems, devices, and methods.

2. Related Art

Polytopic filtering provides the ability to eliminate crosstalk during holographic data recovery (readout) when polytopic multiplexing is used to write (record) data to a holographic storage medium. See, for example, U.S. Pat. No. 7,092,133 (Anderson et al.), issued Aug. 15, 2006; and U.S. Pat. No. 7,167,286 (Anderson et al.), issued Jan. 23, 2007 and Anderson et al., “Polytopic Multiplexing,” Optics Letters 29(12):1402-4 (2004), the entire disclosure and contents of the foregoing documents being hereby incorporated by reference. Polytopic filtering may also provide the ability to select the pixel waves emanating from an addressed hologram while rejecting those emanating from neighboring holograms. This selection may be accomplished by bandpass filtering of the addressed hologram's angular spectrum. Polytopic filtering further provides the ability to conserve the dynamic range (M#) when recording data in a holographic storage medium. Current polytopic filtering techniques involve mechanical filtering with a mechanical mask at the Fourier Transform (FT) plane of a complex FT lens assembly. This complex FT lens assembly is necessitated by the need to operate over a range of temperatures and wavelengths.

### SUMMARY

According to a first broad aspect of the present invention, there is provided a holographic storage system or device comprising: one or more of: a data beam source for generating a data beam or a recovered beam source for generating a recovered beam comprising holographic data recorded in a holographic storage medium; a non-Fourier Transform plane angular filter for carrying out one or more of: angular filtering of the data beam prior to recording holographic data in a holographic storage medium or angular filtering of the recovered beam prior to detecting the recovered holographic data by a detector; wherein the non-Fourier Transform plane angular filter comprises a macrotube array, an etalon, a multi-layer thin film interference coating on a curved surface, a lenslet array device, a waveguide-like array, or a combination thereof.

According to second broad aspect of the present invention, there is provided a method for recording holographic data comprising the following steps: (a) providing a data beam; and (b) passing the data beam through a non-Fourier Transform plane angular filter to carry out angular filtering of the data beam prior to recording holographic data in a holographic storage medium, wherein the non-Fourier Transform plane angular filter comprises: a macrotube array, an etalon, a multi-layer thin film interference coating on a curved surface, a lenslet array device, a waveguide-like array, or a combination thereof.

According to a third broad aspect of the present invention, there is provided a method for recovering holographic data comprising the following steps: (a) providing a recovered beam comprising recovered holographic data; and (b) passing the recovered beam through a non-Fourier Transform plane angular filter to carry out angular filtering of the recovered beam prior to detecting the recovered holographic data by a detector, wherein the non-Fourier Transform plane angular filter comprises: a macrotube array, an etalon, a multi-layer thin film interference coating on a curved surface, a lenslet array device, a waveguide-like array, or a combination thereof.

### BRIEF DESCRIPTION OF THE DRAWINGS

The invention will be described in conjunction with the accompanying drawings, in which:

FIG. 1 is a schematic diagram of a portion of a representative holographic storage system or device illustrating use of a current polytopic/recording filtering system employing a mechanical mask and a 4F relay optical assembly;

FIG. 2 is a diagram illustrating acceptance angle geometry for a simple case;

FIG. 3 is a diagram illustrating acceptance angle geometry for a general case;

FIG. 4 is an image of a macrotube array embodiment which may be useful as an angular filter comprising trenches formed using a Surface Technology System (STS) gas etching process;

FIG. 5 is an image of a macrotube array embodiment which may be useful as an angular filter comprising STS-etched cylindrical holes;

FIG. 6 provides images (at four different magnifications) of a macrotube array embodiment which may be useful as an angular filter comprising wet etched silicon (Si) pipes;

FIG. 7 is a graph of transmittance versus angle for various multi-layer thin film interference angular filters;

FIG. 8 is a schematic diagram illustrating a Fabry-Perot etalon which may be useful as an angular filter;

FIG. 9 is a graph of transmission versus wavelength for a narrow band interference angular filter on a curved surface;

FIG. 10 is a schematic of a readout system showing unfiltered crosstalk during readout between neighboring books;

FIG. 11 is a schematic diagram similar to FIG. 10 but showing crosstalk between neighboring books being filtered out during readout by an interference angular filter coating on a curved lens surface;

FIG. 12 is a schematic cross-sectional diagram of readout using lenslet array-based filtering;

FIG. 13 is a schematic cross-sectional diagram of a fiber optic faceplate;

FIG. 14 is a schematic cross-sectional diagram of the composition of the fiber optic cable with a light-absorbing outer layer applied to the outside of the fibers;

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “light source” refers to a source of electromagnetic radiation having a single wavelength or multiple wavelengths. The light source may be from a laser, one or more light emitting diodes (LEDs), etc.

For the purposes of the present invention, the term “coherent light beam” refers to a beam of light, including waves, with a particular (e.g., constant) phase relationship, such as, for example, a laser beam. A coherent light beam may also be referred to as light in which the phases of all electromagnetic waves at each point on a line normal to the direction of the light beam are identical.

For the purposes of the present invention, the term “data beam” refers to a beam containing a data signal. For example, a data beam may include beams that have been modulated by a modulator such as a spatial light modulator (SLM), along with a beam generated in response to a reference beam impingent on a holographic storage medium, where the generated beam includes data. The modulation of the data beam may be an amplitude, a phase or some combination of the amplitude and phase. The SLM may be reflective or transmissive. The data beam may be modulated into a binary state or into a plurality of states.

For the purposes of the present invention, the term “data modulated beam” refers to a data beam that has been modulated by a modulator such as a spatial light modulator (SLM). The modulation of the data beam may be an amplitude, a phase or some combination of the amplitude and phase.

For the purposes of the present invention, the term “data modulator” refers to any device that is capable of optically representing data in one or two-dimensions from a signal beam.

For the purposes of the present invention, the term “data page” or “page” refers to the conventional meaning of data page as used with respect to holography. For example, a data page may be a page of data (i.e., a two-dimensional assembly of data), one or more pictures, etc., to be recorded or recorded in a holographic storage medium.

For the purposes of the present invention, the term “detector” refers to any type of device capable of detecting something. For example, exemplary detectors may include devices capable of detecting the presence or intensity of light, such as for example, a camera or quad cell, complementary metal-oxide-semiconductor (CMOS) imaging sensors or arrays, charge-coupled device (CCD) arrays, etc.

For the purposes of the present invention, the term “disk” refers to a disk-shaped holographic storage medium.

For the purposes of the present invention, the terms “holographic grating,” “holograph” or “hologram” (collectively and interchangeably referred to hereafter as “hologram”) are used in the conventional sense of referring to an interference pattern formed when a signal beam and a reference beam interfere with each other. In cases wherein digital data is recorded page-wise, the signal beam may be encoded with a data modulator, e.g., a spatial light modulator (SLM), etc.

For the purposes of the present invention, the term “storage medium” refers to any component, material, etc., capable of storing information, such as, for example, a holographic storage medium.

For the purposes of the present invention, the term “holographic storage medium” refers to medium that has a least one component, material, layer, etc., that is capable of recording and storing one or more holograms (e.g., bit-wise, linear array-wise or page-wise) as one or more patterns of varying refractive index imprinted into the medium. Examples of holographic media useful herein include, but are not limited to, those described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), issued Aug. 24, 2004; U.S. Patent Application No. 2003/0206320 (Cole et al.) published Nov. 6, 2003; and U.S. Patent Application No. 2004/0027625 (Trentler et al.), published Feb. 12, 2004, the entire disclosure and contents of which are herein incorporated by reference. A holographic storage medium may be any type of holographic storage medium including: a transparent holographic storage medium, a holographic storage medium including a plurality of components or layers such as a reflective layer, a holographic storage medium including a reflective layer and a polarizing layer so reflection may be controlled with polarization, a holographic storage medium including a variable beam transmission layer that may be pass, absorb, reflect, be transparent to, etc., light beams, grating layers for reflecting light beams, substrates, substrates with servo markings, etc.

For the purposes of the present invention, the term “holographic recording” refers to the act of recording a hologram in a holographic storage medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data.

For the purposes of the present invention, the term “multiplexing” refers to recording, storing, etc., a plurality of holograms in the same volume or nearly the same volume of the holographic storage medium by varying a recording parameter(s) including, but not limited to, angle, wavelength, phase code, shift, correlation, peristrophic, etc., including combinations of parameters, e.g., angle-polytopic multiplexing. For example, angle multiplexing involves varying the angle of the plane wave or nearly plane wave of the reference beam during recording to store a plurality of holograms in the same volume. The multiplexed holograms that are recorded, stored, etc., may be read, retrieved, reconstructed, recovered, etc., by using the same recording parameter(s) used to record, store, etc., the respective holograms.

For the purposes of the present invention, the term “polytopic multiplexing” refers to a multiplexing recording method or technique where the recording books of holograms is spatially overlapped. The spacing between books may be at least the beam waist, which is the narrowest part of the signal beam. An aperture may be placed in the system at the beam waist. During readout, all of the overlapped holograms at a given multiplexing angle may be read out, but only the hologram that is centered in the aperture is passed through to the readout optics. Examples of polytopic recording techniques that may be used in various embodiments of the present invention are described in U.S. Pat. App. No. 2004/0179251 (Anderson et al.), published Sep. 16, 2004; and U.S. Pat. App. No. 2005/0036182 (Curtis et al.), published Feb. 17, 2005, the entire disclosure and contents of which are hereby incorporated by reference

For the purposes of the present invention, the term “mode” refers to a wavelength of light generated by a light source.

For the purposes of the present invention, the term “single mode” refers to a single wavelength of light generated by a light source. For example, a single mode laser produces a single dominant wavelength.

For the purposes of the present invention, the term “multi-mode” refers to multiple wavelengths of light generated by the light source. For example, a multi-mode laser produces multiple wavelengths of light with significant power.

For the purposes of the present invention, the term “optical steering subsystem” refers to any device or combination of devices capable of directing light in a particular direction. Exemplary optical steering subsystems may include a mirror (e.g., a galvo mirror), a combination of mirrors, lenses, and/or other devices, etc.

For the purposes of the present invention, the term “partially reflective surface” refers to any surface of an object capable of reflecting a portion of light while allowing another portion to pass through the surface.

For the purposes of the present invention, the term “plane wave” refers to a constant-frequency wave whose wavefronts (surfaces of constant phase) are substantially or nearly parallel planes of constant amplitude and normal to the direction of the wave and exist in a localized region of space. Exemplary plane waves may include collimated light such as those associated with laser beams for laser pointers, etc.

For the purposes of the present invention, the term “processor” refers to a device capable of, for example, executing instructions, implementing logic, calculating and storing values, etc. Exemplary processors may include application specific integrated circuits (ASIC), central processing units, microprocessors, such as, for example, microprocessors commercially available from Intel and AMD, etc.

For the purposes of the present invention, the term “reading data” refers to retrieving, recovering, or reconstructing holographic data stored in a holographic storage medium.

For the purposes of the present invention, the term “recording data” refers to storing or writing holographic data into a holographic storage medium.

For the purposes of the present invention, the term “recording light” refers to a light source used to record information, data, etc., into a holographic storage medium.

For the purposes of the present invention, the term “phase conjugate,” when referring to a light beam, refers to a light beam which is an exact or very close replica of a second light beam, but propagating exactly or very closely in the reverse direction of the second light beam.

For the purposes of the present invention, the term “phase conjugate optical system” refers to any device (or combination of devices) that causes a reference beam (also referred to as a “reconstruction beam” when used for data recovery) of a holographic storage system or device to be reflected (directed) back along the path of the reference (reconstruction) beam in the opposition direction. Examples of phase conjugate optical systems may include a corner cube, a corner cube array, a controlled electro-optic (EO) crystal, a controlled blazed grating, a holographic grating, surface relief structure, and the combination of a variable layer and a grating (whether a holographic grating or surface relief structure) as shown in, for example, FIGS. 28 and 29 of U.S. patent application Ser. No. 11/840,410, entitled “Monocular Holographic Data Storage System Architecture,” to Curtis et al., filed Aug. 17, 2007, the entire disclosure and contents of which is herein incorporated by reference.

For the purposes of the present invention, the term “recovered beam” refers to a beam generated by the reference (reconstruction) beam. The recovered beam is formed by the phase conjugate reference or normal reference (reconstruction) beam diffracting from a hologram of a data page and being detected by a detector (e.g., a camera).

For the purposes of the present invention, the term “reference beam” refers to a beam of light not modulated with data. Exemplary reference beams include non-data bearing laser beams used while recording data to, or reading data from a holographic storage medium. In some embodiments, the reference beam may refer to the original reference beam used to record the hologram, to a reconstruction beam when used to recover data from the holographic storage medium, or to the phase conjugate of the original reference (reconstruction) beam.

For the purposes of the present invention, the term “refractive index profile” refers to a three-dimensional (X, Y, Z) mapping of the refractive index pattern recorded in a holographic storage medium.

For the purposes of the present invention, the term “dynamic range” or “M#” of a material refers to a conventional measure of how many holograms at a particular diffraction efficiency may be multiplexed at a given location in the material (e.g., recording material layer, holographic storage medium, etc.) and is related to the materials index change, material thickness, wavelength of light, optical geometry, etc.

For the purposes of the present invention, the term “spatial light modulator” (SLM) refers to a device that stores information on a light beam by, for example, modulating the spatial intensity and/or phase profile of the light beam.

For the purposes of the present invention, the term “spatial light intensity” refers to a light intensity distribution or pattern of varying light intensity within a given volume of space.

For the purposes of the present invention, the term “book” or “stack” refers to a group of angle multiplexed holograms that span a particular angular range. A book is a group of angle multiplexed holograms that may be all in one location in the holographic storage medium or slightly shifted from one another or shifted from another group of holograms. The term book refers to both traditional books and composite books.

For the purposes of the present invention, the term “short stack” refers to sub-group of holograms within the address range of a book. For example, a book may be considered as a set of addresses that contain angles 1-500. This angular range may be further separated into “short stacks” so that short stack #1 contains angles 1-100, short stack #2 contains angles 101-200, etc.

For the purposes of the present invention, the term “composite book” refers to a book where at least some of the short stacks of the book do not occupy the same spatial location. In fact, it may be useful to “smear” out any optically induced distortions by placing short stacks in different spatial locations. In a composite book, the spatial locations of the short stacks may partially overlap one another, but differ enough spatially to mitigate any non-ideal media buildup due to multiple recordings in the same location.

For the purposes of the present invention, the term “beam block” refers to any device capable of absorbing light, such as, for example, an incident light beam.

For the purpose of the present invention, the term “waveplate” refers to any device that may be used to change the polarization of light. A waveplate is also sometimes referred to as a retarder and the terms may be used interchangeably herein. Exemplary waveplates, include a λ/4 (quarter) waveplate (QWP) that may be used, for example, to cause a ¼ wavelength phase shift in a light beam that may result in changing linearly polarized light to circular and vice versa, a λ/2 (half) waveplate (HWP) that may be used, for example, to rotate the polarization of a light beam by 90 degrees, etc. Further, for example, a light beam twice passing through a λ/4 waveplate may undergo a 90 degree rotation in the linear polarization of the light.

For the purpose of the present invention, the term “device” may refer to an apparatus, a mechanism, equipment, a machine, a combination of elements, components, etc.

For the purpose of the present invention, the term “holographic storage system or device” refers to a system or device which may record (store) holographic data, which may read (recover) holographic data, or which may record (store) and read (recover) holographic data.

For the purposes of the present invention, the term “Fourier Transform (FT) plane” refers to the back focal plane of a lens. If an image is placed at the front focal plane of the lens this plane will roughly approximate the mathematical Fourier Transform of that spatial signal. For the purposes of the present invention, the FT plane may be any plane that is close or proximate to the back focal plane. In addition, the FT plane need not be an exact mathematical equivalent of the FT of the image as, for example, there may be residual phase terms, field curvature, distortion, and other aberrations in the lens. At roughly the FT plane, the angular spectrum of the image is mapped to spatial positions. This allows for a block/filter to be positioned at the FT plane to filter the angular spectrum of the image (signal).

For the purposes of the present invention, the term “image space” includes the lens and space on the image side of the lens.

For the purposes of the present invention, the term “image plane” normally refers to a particular plane where the image appears.

For the purposes of the present invention, the term “angular filter” refers to a filter that blocks some angles of a light beam and passes some angles of the light beam. Thus, the transmission profile of an angular filter changes with the angle of incidence of the beam.

For the purposes of the present invention, the term “polytopic filter” refers to an angular filter that blocks undesired reconstructions of other pages of data stored at different locations in the holographic storage medium. This may be achieved by filtering the signal to the appropriate bandwidth at the FT plane or outside the FT.

For the purposes of the present invention, the term “non-FT plane angular filter” refers to a filter which performs angular filtering of a data beam and/or a recovered beam, and either limits the angular bandwidth of the data beam or limits the angular bandwidth of reconstructed holograms, but does not include a multi-layer film interference filter coatings on flat or planar surfaces, thicker volumetric holographic (Bragg) gratings, or holographic optical elements (HOEs). Thus, the filter may be a “recording filter” for recording of holograms or a “polytopic filter.” For phase conjugate architectures, recording filters and polytopic filters may be the same filter. Non-FT plane angular filters useful in embodiments the present invention may include macrotube arrays, etalons, multi-layer thin film interference coatings on curved surfaces, lenslet array devices, and waveguide-like arrays.

For the purposes of the present invention, the term “shift-tolerant angular filter” refers to an angular filter, for example a shift-tolerant polytopic filter, that is part of a shift-tolerant lens assembly. A shift tolerant lens assembly is one in which signal-to-noise (SNR) losses are mitigated if holographic storage medium undergoes a shift in any of the three translation directions (X, Y, Z) and/or any of the three rotational directions. SNR losses may be considered mitigated if there is less than half of a 0.5 db loss or less of SNR when a holographic storage medium is shifted by a total of half a book width or less in all three translational directions, i.e., the vector sum of all of the translational shifts is half a book width or less. SNR losses may also be mitigated if there is less than half of a db loss or less of SNR when a holographic storage medium is rotated by a total of 20% of the system numerical aperture (NA) or less in all three rotational directions, i.e., the vector sum of all of the rotational shifts is 20% of the system NA or less. The “system NA” refers to the NA of the lens. See U.S. application Ser. No. 11/846,221, entitled “Shift Tolerant Lens Optimized for Phase Conjugating Holographic Systems” to Sissom et al., filed Aug. 28, 2007, the entire disclosure and contents of which are herein incorporated by reference.

For the purposes of the present invention, the term “angular filtering” refers to filtering which limits the angular bandwidth of the signal (data) beam which is to be recorded by a holographic storage medium, or a reconstruction (recovered) beam which is detected by a detector.

For the purposes of the present invention, the term “waveguide” refers to a structure which guides waves, such as electromagnetic, optical, or sound waves. Optical waveguides are typically dielectric waveguides, structures in which a dielectric material with a high permittivity, and thus a high index of refraction, is surrounded by a material with lower permittivity and guides optical waves by total internal reflection. The most common optical waveguide is an optical fiber.

For the purposes of the present invention, the term “waveguide-like array” refers to light pipes or groups, clusters, etc., of optical waveguides.

For the purposes of the present invention, the term “lenslet” refers to small lenses that comprise or make up a lenslet array.

For the purposes of the present invention, the term “lenslet array” refers to a plurality or set of lenslets in the same plane. Each lenslet of the array may have the same focal length.

For the purposes of the present invention, the term “lenslet array device”” refers to a device comprising a lenslet array, as well as other components, elements, etc., that may be used for angular filtering. For example, the lenslet array device may be a lenslet array imaging assembly where the lenslet array images rays of light onto an array of apertures. In a lenslet array imaging assembly, the lenslet array may have tubes (one for each lenslet) that are between the lenslet and the corresponding aperture that block light from going from one lenslet to a different aperture other than the aperture that is in the direct path from the lenslet and within that particular tube. Where the tubes are long enough and comprise light absorbing materials, or comprise wall surfaces having coatings of light absorbing materials, the tubes may function as the block (filter) so that the apertures may be omitted from the lenslet array imaging assembly.

For the purposes of the present invention, the term “acceptance angle” refers to any angle of light that may pass through the filter.

For the purposes of the present invention, the term “macrotube” refers to a tube that is relatively large in diameter as compared to the wavelength of light.

For the purposes of the present invention, the term “macrotube array” refers to a plurality of macrotubes that are grouped, clustered, etc., together.

For the purposes of the present invention, the term “interference filter” (also known as a “dichroic filter”) refers to is an optical filter that reflects one or more spectral bands or lines and transmits others, while maintaining a nearly zero coefficient of absorption for all wavelengths of interest. An interference filter may be high-pass, low-pass, bandpass, or band-rejection.

For the purposes of the present invention, the term “etalon” or “Fabry-Perot interferometer” refers to a device comprising a transparent plate with two reflecting surfaces (normally what is referred to as an etalon), or may refer two parallel highly reflecting mirrors (normally what is referred to as an interferometer). An etalon's transmission spectrum as a function of wavelength exhibits peaks of large transmission corresponding to resonances of the etalon.

For the purposes of the present invention, the term “band of angles” refers to a group of angles measured from a common reference (e.g., a plane). For example, 0 to 10 degrees off normal from the plane is a band of angles defined collectively from a common reference, and refers to all angles between 0 and 10 inclusive.

For the purposes of the present invention, the term “bandpass filter” refers to a device that passes frequencies within a certain range and rejects (attenuates) frequencies outside that range. An example of an analogue electronic band-pass filter is a resistor-inductor-capacitor (RLC) circuit. These filters may also be created by combining a low-pass filter with a high-pass filter. A bandpass filter may also include a low pass filter

For the purposes of the present invention, the term “angle of incidence” refers to the angle between a beam incident on a surface and a line perpendicular to the surface at the point of incidence, i.e., the “normal.”

For the purposes of the present invention, the term “normal incidence” refers to a ray that hits a surface perpendicular to that surface.

For the purposes of the present invention, the term “filter effective index of refraction” refers to the average index of refraction of a filter's structure.

For the purposes of the present invention, the term “angular spectrum” refers to the range of angles that a data signal or data page comprises or is made up of. For polytopic multiplexed holograms where multiple multiplexed pages are reconstructed, this range may refer to the entire range of angles possessed by all reconstructed pages.

For the purposes of the present invention, the term “Nyquist limit” refers to the standard, conventional meaning of this term where a band-limited signal may be exactly reconstructed if sampled at least to twice the maximum frequency of the signal.

For the purposes of the present invention, the term “objective lens” refers to the lens that is closest to the holographic storage medium which the data beam passes through for reading or writing holograms, and which may also be referred to as a “storage lens,” “object lens,” “reader lens,” etc.

For the purposes of the present invention, the term “z-shift tolerant” refers to a holographic storage system where the holographic storage medium may change position along the axis of the optical system without significantly affecting the ability of the of the system to write (record) or read (reconstruct) data.

For the purposes of the present invention, the term “z-servo” refers to a system which may position the optical system along the optical axis with respect to some signal. An example of a z-servo in a conventional DVD or CD is a focus servo system.

For the purposes of the present invention, the term “telecentricity” refers to a property of certain multi-element lens designs in which the chief rays for all points across the object or image are nearly or very nearly collimated.

For the purposes of the present invention, the term “total internal reflection” refers to an optical phenomenon that occurs when a ray of light strikes a medium boundary at an angle larger than the “critical angle” with respect to the normal to the surface. If the refractive index is lower on the other side of the boundary, no light can pass through, so effectively all of the light is reflected. The “critical angle” is the angle of incidence above which the total internal reflection occurs.

For the purposes of the present invention, the term “fiber boule” refers to a mass of glass from which optical fibers may be pulled from during manufacture or a group of optical fibers which may be glued or otherwise attached together.

For the purposes of the present invention, the term “pixel pitch” refers to the distance between the centers of adjacent pixels on an SLM or a detector.

For the purposes of the present invention, the term “photonic-crystal fiber (PCF)” refers to a class of optical fibers based on the properties of photonic crystals (periodic optical (nano)structures designed to affect the motion of photons in a similar way that periodicity of a semiconductor crystal affects the motion of electrons). PCFs may include photonic-bandgap fiber (PCFs that confine light by band gap effects), holey fiber (PCFs using air holes in their cross-sections), hole-assisted fiber (PCFs guiding light by a conventional higher-index core modified by the presence of air holes), Bragg fiber (photonic-bandgap fiber formed by concentric rings of multilayer film), etc.

For the purposes of the present invention, the term “window” refers to a piece, element, component, etc., of glass, plastic, etc., which is positioned, placed, located, etc., on another element, component, etc., for protection, but which allows the other element component, etc., to receive a light beam. For example, a camera chip may have a window for the purposed of protection.

### DESCRIPTION

Filtering of a data beam before recording the hologram (in order to make the hologram smaller) is desirable in holographic data storage systems. This is particularly important for page-based holographic storage systems that store holograms in the FT plane in or near the holographic storage medium. The spatial light modulator (SLM) that encodes the data beam may have higher diffraction orders that may need to be filtered out. In addition, the zeroth order may need to be further filtered to be closer to the Nyquist limit of the signal (the natural zeroth order is twice the linear Nyquist limit or four times the required area needed to store the information). By filtering the data beam before recording, the hologram may be made much smaller and therefore may result in much higher achievable data storage densities. Thus, all holographic storage systems involving parallel recording may require filtering before storage of the hologram regardless of architecture or multiplexing method. Examples of such architectures may include: angle-polytopic phase conjugate architecture, co-linear architecture, monocular architectures, etc. Examples of multiplexing methods may include: angle, wavelength, phase code, shift, correlation, polytopic, peristrophic, angle-polytopic, etc.

Angular filtering has traditionally been carried out at the FT plane because the angle of incidence is mapped to a position at this plane. Thus, a filter may be placed at the FT plane to achieve traditional angular filtering. But in embodiments of the present invention, angular filtering is instead carried on outside the FT plane (i.e., at the non-FT plane) to avoid the complexity, size increase, and cost of generating a FT plane to be filtered at. In addition, known angular filters for carrying out angular filtering include multi-layer interference filters on flat or planar windows, thicker Bragg gratings, and holographic optical elements (HOEs). See U.S. Pat. No. 7,092,133 (Anderson et al.), issued Aug. 15, 2006; and U.S. Pat. No. 7,167,286 (Anderson et al.), issued Jan. 23, 2007. But for holographic data storage the transition from blocked (filtered) to passed needs to be relatively sharp at lower angles of incidence, relatively invariant to temperature (±20° C. may be common for data storage products) and some small wavelength changes (e.g., from about 0.5 to about 8 nm are typical for holographic storage systems). Thicker Bragg gratings, as well as HOEs, are known for their sensitivity to temperature and wavelength, while multi-layer filter coatings on planar surfaces are known not to work well for lower angles of incidence. Thus, these methods for angular filtering, as traditionally practiced, may not be practical to use in a holographic storage system or device.

The several embodiments of the present invention also provide angular filtering that avoids the need for mechanical masks and/or complex lens assemblies, thus resulting in significant size and cost improvements. The several embodiments of the present invention further provide filtering before recording that minimizes the size of the recorded holograms, thus minimizing the volume of the recorded hologram in the holographic storage medium for better storage density and use of the dynamic range of the medium.

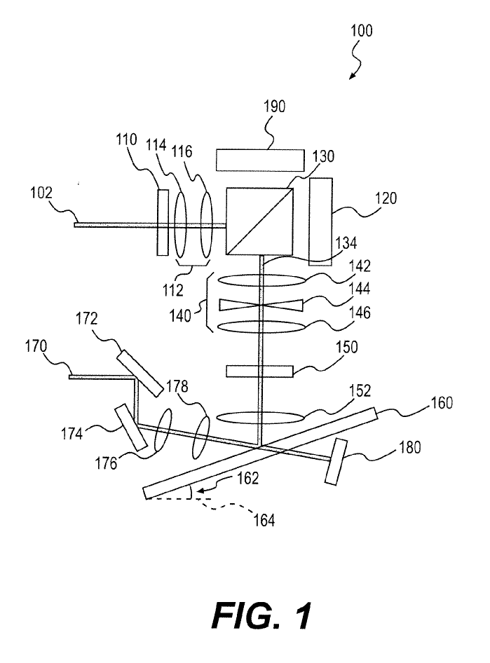

The problems of angular filtering in holographic storage systems and devices using current polytopic/recording filtering system is illustrated by reference to FIG. 1. FIG. 1 provides a schematic diagram of a portion of a representative holographic storage system or device 100 illustrating a current polytopic/recording filtering system employing a mechanical mask and relay lenses. In system/device 100, beam 102 passes through phasemask 110 and relay lens assembly 112 comprising lenses 114 and 116. Phasemask 110 is imaged onto spatial light modulator (SLM) 120 by lenses 114 and 116 via polarizing beam splitter (PBS) 130. SLM 120 modulates beam 102 to encode information to provide data beam 134. Data beam 134, on exiting SLM 120, is then directed by PBS 130 to pass through relay lens assembly 140, comprising first lens 142, polytopic/recording filter 144, which bandpass filters the signal on recording (i.e., functions as a recording filter), and second lens 146. Filter 144 may provide, for example, approximately from 0.95 to 2.2 Nyquist filtering in the linear dimension. In relay lens assembly 140, data beam 134 is filtered to the desired hologram's angular spectrum by filter 144 positioned between lenses 142 and 146. From relay lens assembly 140, data beam 134 passes through a switchable half waveplate (HWP) 150 (which may be used to optionally rotate the polarization of data beam 134 by 90 degrees), and then through a storage lens 152. Data beam 134 is approximately Fourier Transformed by storage lens 152 into holographic storage medium 160. Storage lens 152 may have a high numerical aperture (for example, from 0.5 to 0.85) to minimize the size of the hologram recorded in holographic storage medium 160. Holographic storage medium 160 is shown FIG. 1 as being positioned at a predetermined angle 162 relative to a plane 164 normal (perpendicular) to data beam 134.

System/device 100 also includes a reference beam 170 which is directed by mirrors 172 and 174 through lens 176 and lens 178 and then onto holographic storage medium 160. Lenses 176 and 178 image reference beam 170 from mirror 174 onto holographic storage medium 160 so that a change of angle of mirror 174 corresponds to the change of angle of reference beam 170 but without changing the location at which beam 170 is directed into medium 160. Reference beam 170 and data beam 134 intersect and interfere to form a hologram in holographic storage medium 160. When the mode of operation of system/device 100 is for recovering (reading) data, reference beam 170 (also referred to as a reconstruction beam when recovering data) may pass through medium 160 to mirror 180 (e.g., a galvo mirror) to be reflected (directed) back as a phase conjugate beam through holographic storage medium 160 to reconstruct recorded holographic data from medium to provide a reconstructed beam containing the reconstructed holographic data (also be referred to as a recovered beam). The recovered beam is then be diffracted back along the original data beam 134 path to camera 190 which may convert the reconstructed holographic data to a signal and transmit the signal to drive electronics (not shown). This mode of data recovery may be referred to as phase conjugate reconstruction.

In high capacity polytopic multiplexing of holographic data in current polytopic/recording filtering systems such as system/device 100, a Fourier Transform (FT) plane is required for filtering the signal and is why relay lens assembly 140 is required in system/device 100. In system/device 100, SLM 120 and camera 190 are imaged to the back focal plane of storage lens 152 by using, for example, a standard four focal length with two lenses (4F) relay optical assembly for relay lens assembly 140. This 4F relay optical assembly 140 allows access to the FT plane at which a mechanical mask is placed as polytopic/recording filter 144. This mechanical mask may comprise a small hole in a metal plate positioned between lenses 142 and 146 of 4F relay optical assembly 140, with the hole being aligned to the optical axis of the 4F relay optical assembly. Because 4F relay optical assembly 140 may have to operate over a range of temperatures and wavelengths, assembly 140 may comprise a fairly complex lens assembly (for example, may have four separate lens element for each assembly 140).

In order to simplify the optical path and make system/device 100 smaller, less expensive, with potentially better tolerance, and more reliable, the present invention provides several embodiments of an angular filter that may achieve the same bandpass filtering function without using relay lenses (e.g., lenses 142 or 146) or mechanical masks (e.g., a metal plate with a small hole), as shown in FIG. 1. Five embodiments of non-Fourier Transform (FT) plane angular filters useful in the present invention are illustrated herein: (1) macrotube arrays (including groups of STS etched cylindrical tubes and wet etched Si pipes); (2) etalons; (3) multi-layer thin film interference coatings on a curved surface; (4) lenslet array devices; and (5) waveguide-like arrays, as well as combinations of these five embodiments (for example, one of angular filter embodiments (1), (2), (4) or (5) may be used with the SLM, while a different one of these angular filter embodiment is used with the detector, e.g., a camera). Four of these five embodiments (macrotube arrays, etalons, lenslet array devices and waveguide-like arrays, or combinations thereof) may be used, positioned, located, etc., in the image space of a telecentric Fourier Transform (FT) lens. The remaining embodiment (3) (multi-layer thin film interference coating on a curved surface) may be used, positioned, located, etc., between the FT plane and the image plane on a curved surface of, for example, a lens or window. The various embodiments of the non-FT plane angular filters of the present invention permit high capacity polytopic multiplexing of holographic data without the need of relay lenses or mechanical masks. Eliminating relay lenses (e.g., 4F relay lens assemblies such as 140) and mechanical masks (such as for polytopic filter 144) greatly reduces the cost, size and complexity of these holographic data storage systems and devices. In many instances, elimination of these components may also relax tolerances and improve manufacturability of such systems and devices. While some embodiments of the non-FT plane angular filters of the present invention given herein are used to illustrate writing (recording) holographic data, or to illustrate reading (recovering) holographic data, all embodiments of the non-FT plane angular filters of the present invention illustrated herein may be used for either data writing (recording) or data recovery (readout). In other words, the holographic storage system or device may be a recording system/device, a readout system/device, or both a recording and readout system/device.

In embodiments of the present invention where the non-FT plane angular filter is a macrotube array, etalon, lenslet array device or waveguide-like array, the non-FT plane angular filter may be used, positioned, located, etc., in the image space. Such non-FT plane angular filters used, positioned, located, etc., in the image space limit the angular bandwidth emitted by or accepted into a pixel element. These pixel elements may be SLM pixels for recording holographic data or detector pixels for reading holographic data. Because these non-FT plane angular filters limit the angular spectrum at the image plane, the same angular filter may be used across the image, thus the center ray of all pixels across the image field are the same. An embodiment of a lens form that may achieve this effect is a telecentric lens wherein all center rays of the pixels are parallel to the optical axis.

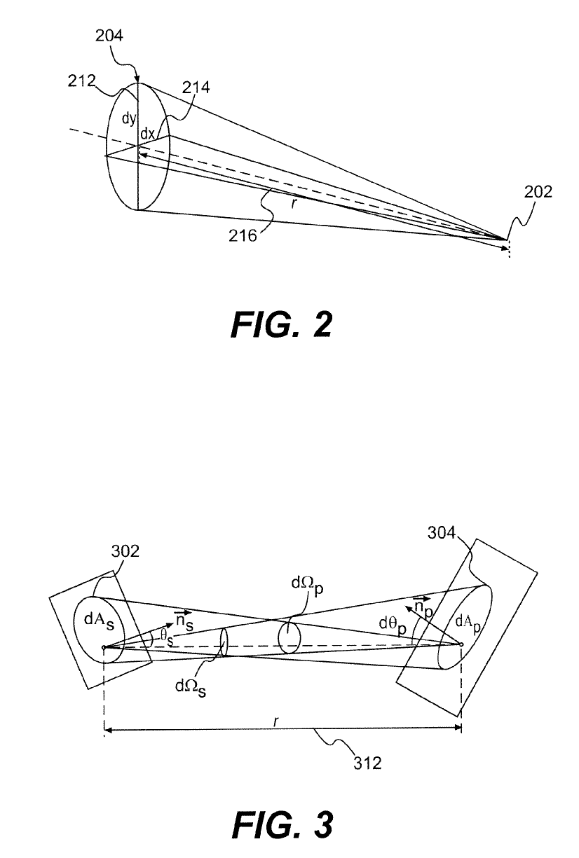

FIGS. 2 and 3 illustrate, respectively, the acceptance angle geometry for the simple and general cases which one or more embodiments of the non-FT plane angular filters of the present invention may use or implement to control angular filtering as described hereafter. FIG. 2 is a diagram illustrating acceptance angle geometry for the simple case involving a pixel 202 with infinitesimal area at the bottom of an elliptical hole or aperture 204 with minor axis 212 having a length dx and major axis 214 having a length dy. Elliptical aperture 204 is located at a distance r from pixel 202, as indicated by double-headed arrow 216. The acceptance angle is the angular spectrum or rays propagating through elliptical aperture 204 and reaching pixel 202. The acceptance angle in the x direction is represented by atan(dx/r), while the acceptance angle in the y direction is represented by atan(dy/r). The acceptance angle may be controlled by selecting the values for the size of elliptical aperture 204 (as defined by length dx and length dy) and the distance r (i.e., how far aperture 204 is located from pixel 202).

FIG. 3 is a diagram illustrating an acceptance angle geometry for the general case. In the general case, hole or aperture 302 and pixel 304 have areas, dAₛ and dAₚ, respectively, which are finite. Aperture 302 and pixel 304 are located apart by a distance r indicated by double-headed arrow 312. Aperture 302 is able to tilt at an angle θₛ, as measured from the ray nₛ (normal to the surface of aperture 302). Pixel 304 is also allowed to tilt at an angle θₚ, as measured from the normal to the surface of pixel 304 to ray nₚ. Acceptance angle calculations may also use differential areas dΩs and dΩp, respectively. The acceptance angle may be controlled by appropriately selecting opening hole area dAₛ, pixel area (size) dAₚ, hole depth r, and the angles θₛ of hole opening 302 and θₚ of pixel 304.

The geometry of FIG. 3 may be directly implemented to control the acceptance angle using, for example, macrotube arrays. In one embodiment of macrotube arrays, arrays of square-shaped macrotubes (which may also be other shapes, such as, for example, rectangular, circular, elliptical, etc.) may be used. The opening of the macrotube corresponds to the acceptance area, the length of the tube corresponds to the distance r, and the diameter or pitch of the array may be made to match the pixel pitch of the SLM or detector. Ideally, the walls of the macrotube are very thin so as to not significantly change the fill-factor of the SLM or detector. (“Fill factor” refers to the amount of area on a silicon chip that may be used for light collection or modulations. For example, a detector camera having a pixel pitch of 10 microns, but only a 9 micron pixel, where the remainder of the camera is used for circuitry, has a fill factor of 90%.) The walls of the macrotube absorb the light that strikes the walls so that those angles do not pass completely through the macrotube.

In one embodiment of a macrotube array, 3 micron wide square-shaped macrotubes may be etched in a silicon substrate to a 41 micron depth and with a 4.6 micron pitch. The macrotubes may be matched to the CMOS pixels with a lithographically patterned etch, e.g., in the embodiment, the pixels would match 4.6 micron pitch. About a 1° sidewall etch slope may result which provides a 0.73 micron width difference between opposing tube ends. As a result, the specific wall thickness may not be exactly known. The etch rate may be about 2 microns/minute. The silicon substrate may be oriented to preferentially etch squares. Etched dies may be free standing over the small dimensions of the CMOS sensor. For the resulting etched macrotube array, the silicon absorbs the light that strikes it so as to not to completely pass through and out of the macrotube. Thus, only angles of the incident light that may be incident on the macrotube opening (3 um) at an angle that does not strike the wall before striking the pixel (distance of 41 microns) are allowed to pass through the macrotube, which thus functions as an angular filter.

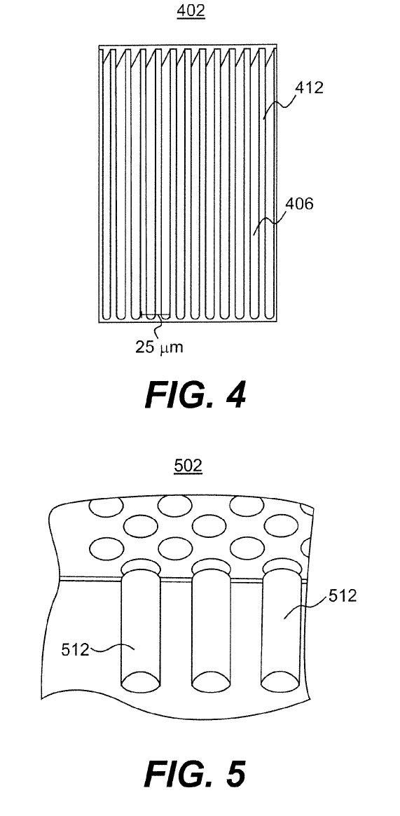

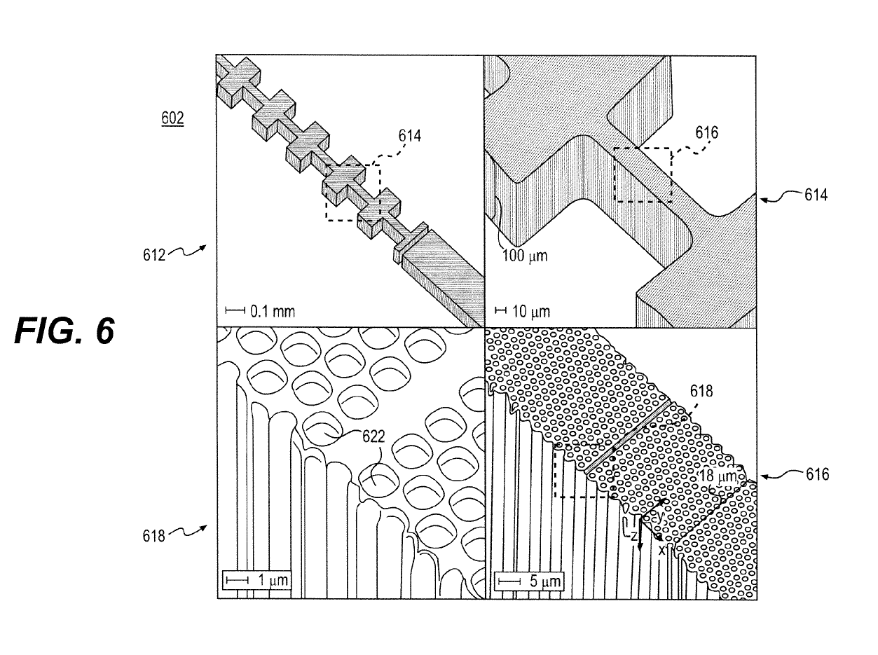

Some embodiments of these arrays of macrotubes are further illustrated in FIGS. 4-6. In FIG. 4, one macrotube array embodiment 402 comprises trenches or grooves 406 having a depth of 3 microns and a width of 4 microns may be formed in a silicon substrate using a Surface Technology System (STS) gas etching process to provide a plurality of walls 412. In FIG. 5, one macrotube array embodiment 502 comprises a plurality of cylindrical holes 512 formed using a STS gas etching process. In FIG. 6, one macrotube array embodiment 602 (shown at four different magnifications 612, 614, 616 and 618) comprises a plurality of silicon (Si) pipes 622 formed by using a wet etching process. The embodiments of FIGS. 4-6 illustrate how such macrotube arrays may be formed. These macrotube angular filters may be positioned at the image plane of the system (e.g., before the SLM or camera). In other embodiments, these macrotube angular filters may be fabricated on or as part of these elements (e.g., as part of the SLM or camera, the objective lens, etc.). For processes which may be used for etching silicon substrates to form macrotube arrays, see, for example, U.S. Pat. No. 6,051,503 (Bhardwaj et al.), issued Apr. 18, 2000; U.S. Pat. No. 6,187,685 (Hopkins et al.), issued Feb. 13, 2001; U.S. Pat. No. 6,261,962 (Bhardwaj et al.), issued Jul. 17, 2001; U.S. Pat. No. 6,355,181 (McQuarrie), issued Mar. 12, 2002; U.S. Pat. No. 6,933,242 (Srinivasan et al.), issued Aug. 23, 2005; and U.S. Pat. No. 7,141,504 (Bhardwaj), issued Nov. 28, 2006, the entire disclosure and contents of the foregoing patent documents being hereby incorporated by reference.

An interference filter according to one embodiment of an angular filter of the present invention may comprise multiple thin layers (multi-layer thin film) of dielectric material (e.g., diamond, fluorides, such as magnesium fluoride, silicon, silicon dioxide, silicon carbide, germanium, silicon germanide, arsenic, gallium arsenide, etc.) having different refractive indices. In addition to dielectric layers, the interference filter may also comprise metallic (including metallic oxide) layers (e.g., aluminum, gold, silver, tin oxide, copper, alloys, etc.). Interference filters may also comprise etalons that may be implemented as tunable interference filters. Interference filters are wavelength-selective by virtue of the interference effects that take place between the incident and reflected waves at the thin-film boundaries.

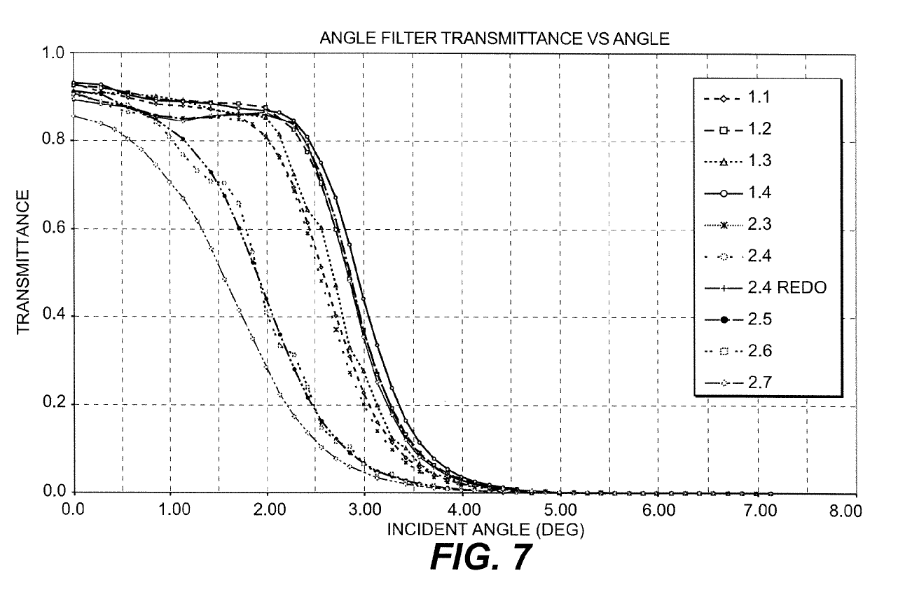

A multi-layer thin film (e.g., coating) may be used to form an interference angular filter that rejects higher angles. For example, the interference angular filter may comprise a stack having many layers of dielectric materials (e.g., upwards of about 100 layers or more) and may be designed for a particular wavelength (e.g., green). Such an interference angular filter rejects a band of angles, but not the whole spectrum. This works for holographic data recovery (readout), using a camera, but higher angles generated by higher orders of the SLM may not be blocked (filtered) when recording holographic data. Accordingly, such an angular rejection filter may be used as a readout filter as is, but may need to be combined with another technique (e.g., a thicker Bragg grating) if the angular rejection filter is to be used as a recording filter. FIG. 7 represents a graph of transmittance versus angle for these various interference angular filters which shows the measured pass-band for various samples of such films used in these filters. Higher angles than those shown in FIG. 7 are also passed. An interference angular filter comprising a 100 layer stack has a very large number of layers and may not be practical for a lower cost holographic data drive. In fact, the graph presented in FIG. 7 shows a fair amount of variation between the various fabricated interference angular filters due to the stack complexity.

The reason that many layers may be required for such interference angular filters is that many holographic data storage systems or devices want to pass the DC (i.e., the ray that goes down the optical axis or the spatial frequency represented by a uniform field or 0 frequency), as well as some smaller angles, and then sharply reject all other higher angles. Requiring a rejection at lower angles (i.e., a few degrees from normal) requires a very large number of layers in the stack for the interference angular filter. In addition, these interference angular filters may be very sensitive to wavelength changes and potential temperature changes. Variations in both of these conditions may need to be accommodated in a practical data storage system or device.

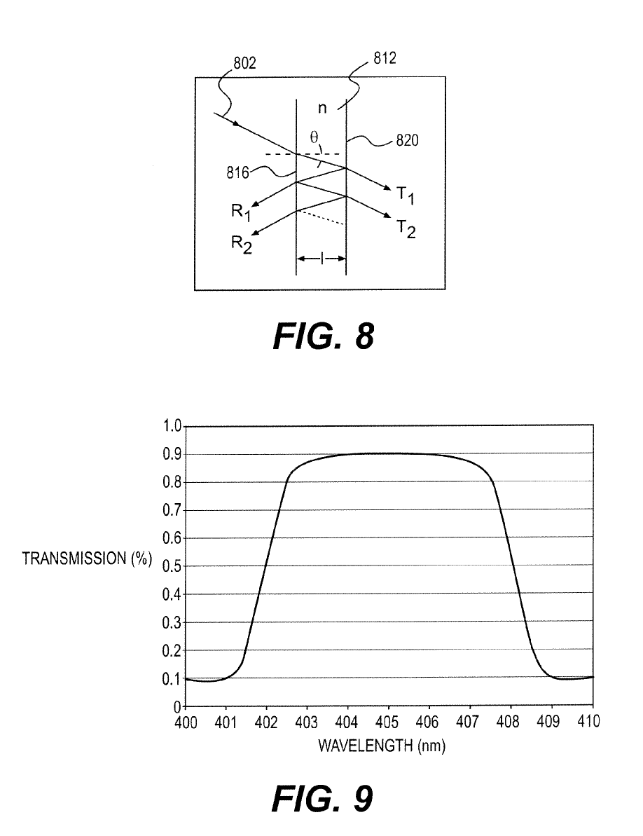

A similar response to those shown FIG. 7 for interference angular filters may be achieved using a single resonator such as a Fabry-Pérot Etalon, as illustrated in FIG. 8. In FIG. 8, a light beam 802 enters etalon 812, having a thickness l and undergoes multiple internal reflections as indicated by reflected beams R₁ and R₂. Light that is transmitted through etalon 812 is indicated by transmitted beams T₁ and T₂. θ represents the angle that the light travels through etalon 812 and n represents the refractive index of the material between reflecting surfaces 816 and 820 of etalon 812. Etalon 812 may be placed at the image plane to filter out undesired angular spectrum. In addition, just like an interference filter (as described below), etalon 812 may be advantageously placed on a curved surface (e.g., formed by two curved surfaces) with the curvature centered at or near the hologram center.

Another embodiment of an angular filter useful in the present invention involves placing an angular interference filter on a curved surface. Because of the problems with interference angular filters placed on planar or flat surfaces, it was discovered that placement of interference angular filter on a curved surface may be used to solve these problems by providing improved low angle response, higher angle rejection, temperature and wavelength insensitivities, etc. The curved surface may be designed to be modestly close (e.g., at from about 10 to about 20% of the focal length) to be centered on the hologram being recorded in the holographic storage medium. This allows the DC of the pixels passed by the storage lens to go through normal to this curved surface. If other angles that are smaller cross the angular interference filter at a higher angle due to the surface curvature, these angles may be to filtered out using a smaller and reasonable number of layers in the filter (e.g., from about 1 to about 40 layers). In addition and in combination with applying layers having different refractive indexes, the curved surface may be patterned to effectively change the refractive index without having to apply other materials. For example, by etching or removing material on the surface, the surface's effective refractive index may be changed, the transmission of certain angles of incidence may be changed, etc. By employing an interference filter on a curved surface centered roughly on the hologram the problems of using such filters may be solved or at least minimized so that such interference filters may be more practical to use (economical, have appropriate sensitivities, etc).

Bandpass filters are often designed for normal incidence. But when the angle of incidence of the incoming light is increased from zero, the central wavelength of the filter decreases, resulting in partial tunability. If λ_{c} is the central wavelength under an angle of incidence θ<20°, λ₀ is the central wavelength at normal incidence, and n* is the filter effective index of refraction, then formula (1) applies:

$${λ}_{c} = {λ}_{0} ( 1 - \frac{{θ}^{2}}{2 {n}^{* 2}} ) \qquad ( 1 )$$

This principle may be used to reject or tune out higher angle pixels waves from adjacent holograms for some embodiments of angular filters of the present invention, for example interference filters placed on curved surfaces.

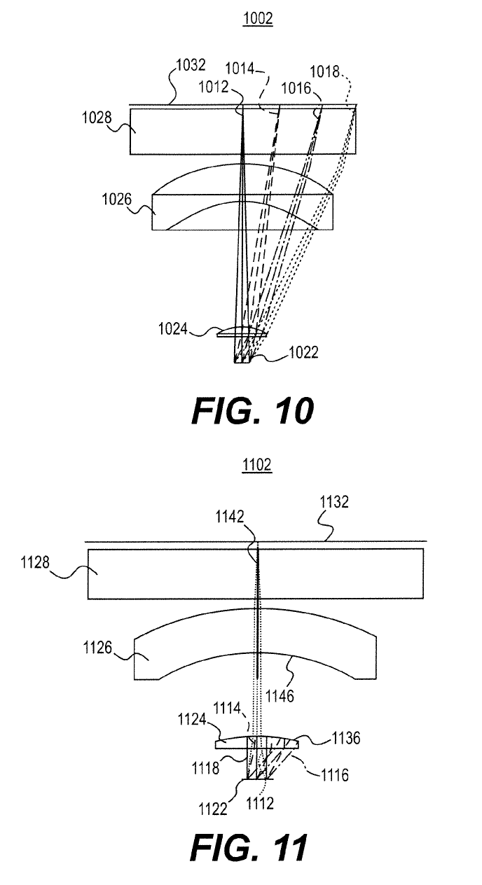

A shift-tolerant angular (e.g., polytopic) filter may be used to select the angular spectrum of the addressed book using a narrow band thin film interference angular filter positioned or placed on a curved surface, as illustrated in FIG. 9. FIG. 9 shows the transmission of a simple interference filter (e.g., comprising a couple of layers) versus wavelength. Such an interference filter is relatively easy to make, but may have a larger angle of acceptance and may pass smaller angles if placed on a flat surface where the light is the right wavelength. Instead, if a curved surface is used in place of the flat surface and has a radius approximately equal to the surface's distance from the FT plane, the filter's angular pass-band may be modified so that the angular spectrum of the addressed book has an approximately zero angle of incidence on the curved surface. On recording, the angular spectrum of the zeroth order of the SLM will also has a smaller angle of incidence on the curved surface, but spectra from other orders of the SLM will have larger angles of incidence on the curved surface and will be filtered out. On readout, since the center wavelength (i.e., middle of the pass-band) of the narrow band interference filter shifts with angle of incidence, spectra from adjacent books are filtered out, as is illustrated in FIGS. 10 and 11.

FIG. 10 is a schematic of a readout system 1002 showing unfiltered crosstalk between neighboring books during readout. In readout system 1002, spectra 1012 is the desired reconstruction of a single pixel in the data page, while 1014, 1016 and 1018 are spectra of single pixels from adjacent books recorded in holographic storage medium 1022. When medium 1022 is illuminated by a reference (reconstruction) beam (not shown), all of the spectra are reconstructed and pass through the reader lens, which comprises a first lens 1024 and a second lens 1026. The reconstructed spectra passing through the reader lens then pass through camera cover glass 1028 and are read (detected) at camera 1032. The reconstruction from spectra 1012, 1014, 1016 and 1018 are not filtered out and may result in very significant noise when read at camera 1032.

FIG. 11 shows a readout system 1102 similar to system 1002 in which spectra 1112 is the desired reconstruction of a single pixel in the data page, while 1114, 1116 and 1118 are spectra of single pixels from adjacent books in holographic storage medium 1122. When medium 1122 is illuminated by a reference (reconstruction) beam (not shown), all of the spectra are reconstructed and are directed to reader lens, which comprises lens 1124 and a lens 1126. The reconstructed spectra which pass through the reader lens then pass through camera cover glass 1128 and are read at camera 1132. But unlike system 1002, the first lens 1124 of the reader lens has an interference filter coating applied on or to curved surface 1136 of first lens 1124. This coating passes only the desired spectra of lower angle pixel 1112 along optical axis 1142, but blocks (filters) the higher angle pixel spectra 1114, 1116 and 1118 from adjacent books recorded in holographic storage medium 1122. Thus, only the desired spectra (e.g., 1112) from that recovered page reaches camera 1132 and is readout. Crosstalk between spectra 1114, 1116 and 1118 are thus filtered out by the coating on curved surface 1136 of first lens 1124, thus causing first lens 1124 to act or function as a narrow band interference filter.

As illustrated in FIG. 11, the curved surface of the interference angular filter may be chosen to be the surface of a lens (e.g., a reader lens). In some embodiments, internal lens surfaces (e.g., the opposed facing surfaces 1136 of first lens 1124 and 1146 of second lens 1126) may provide enhanced isolation due to refractive effects. There are several advantages to using a thin film interference coating on a curved surface as an angular filter. For example, the angular filter may be implemented inexpensively using a thin film interference coating on the curved surface. The angular filtering may also be z-shift tolerant, with no z-(e.g., polytopic) servo being required. The angular filtering may also be insensitive to tilting of the holographic storage medium or the camera. The stray light may be filtered prior to being detected by the camera. Telecentricity at the camera also may not be required because the filtering is not done near an image plane and thus the surface may change to compensate for non-telecentric behavior, i.e., the curved surface does not have to be a spherical surface. The lens size may also be minimized because telecentricity is not required to be designed in. In addition, when used with a shift tolerant lens, all z-servos may be eliminated. While the embodiment of FIG. 11 has been described with respect to readout, the same concept would also apply for recording, in that the coating on the curved surface filters the data signal from the SLM before being recorded in the holographic storage medium.

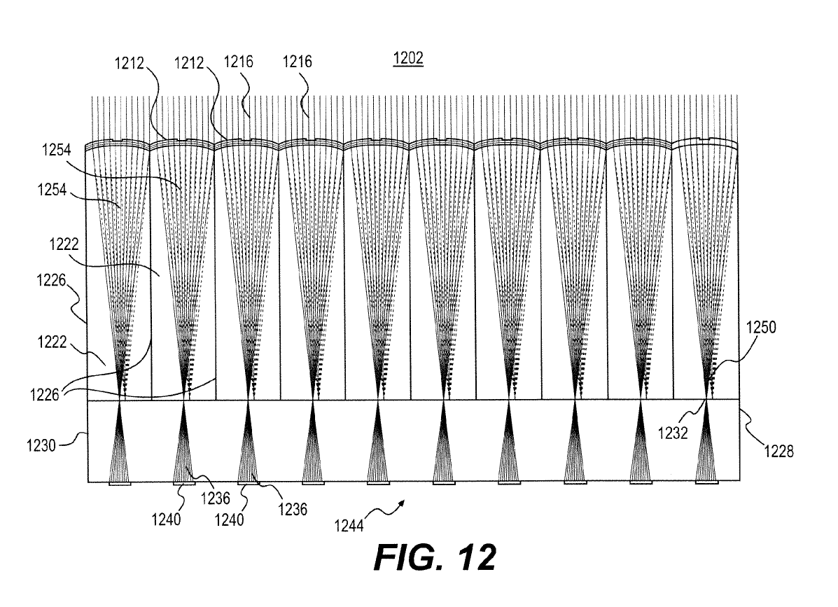

Lenslet array-based filtering using a lenslet array device which employs the same operating principle as macrotube array filtering by directly implementing the acceptance angle geometry of FIG. 3 is illustrated in FIG. 12. FIG. 12 shows a schematic cross-sectional diagram of readout using lenslet array-based filtering. In FIG. 12, a lenslet array device in the form of, for example, a lenslet array imaging assembly 1202 comprises a plurality of lenslets (lenslet array) 1212 which provide incident rays 1216. Lenslet array 1212 is attached to or integral with a plurality of incident ray focusing tubes 1222, one for each lenslet 1212. Tubes 1222 each have generally parallel opposing and spaced apart light-absorbing walls 1226. The incident rays 1216 from lenslet array 1212 are focused through tubes 1222 onto a filter plane 1228 of cover glass 1230. Angular filters in the form of a plurality of intermediate apertures 1232 are formed in a light-absorptive coating at filter plane 1228 on cover glass 1230. Rays 1216 which pass through intermediate apertures 1232 provide exiting rays 1236 which strike pixels 1240 in sensing area 1244. Intermediate apertures 1232 provide a small acceptance angle 1250. Similar to image plane filters, lenslet array 1212 focuses some of rays 1216 to pass through apertures 1232 if the angle of incidence is small enough. If the angle of incidence is too large, as shown by dashed lines 1254, the remaining rays 1216 will be focused to a different location and blocked (filtered out) by the absorptive coating at the filter plane 1228 on glass 1230 which surrounds the array of filter apertures 1232.

Light-absorbing walls 1226 of tubes 1222 may be made of light absorbing materials or may be coated with light absorbing materials. In an alternate embodiment, if tubes 1222 are long enough so as to filter out remaining rays 1216 having larger angles of incidence 1254, apertures 1232 and filter plane 1228 may be omitted. In addition, pixel elements 1240 may function in place of apertures 1232. Because refraction occurs at the opening of apertures 1232, more energy may be concentrated on a single pixel 1240, or smaller intermediate apertures 1232 may be used in assembly 1202 of FIG. 12. Because apertures 1232 in FIG. 12 are very small, the acceptance angle geometry of FIG. 2 may be reproduced for this embodiment.

In another embodiment of angular filters useful in the present invention, waveguide-like arrays may be used. The acceptance angle of a waveguide may be determined by total internal reflection. Waveguides may be dielectric waveguides, i.e., structures in which a dielectric material with high permittivity, and thus a high index of refraction, is surrounded by a material with lower permittivity. These dielectric waveguide structures guide optical waves by total internal reflection. The most common optical waveguide is an optical fiber. By placing the waveguides at the image plane, the waveguides may also be used to filter the signal by limiting the acceptance angle into the waveguide.

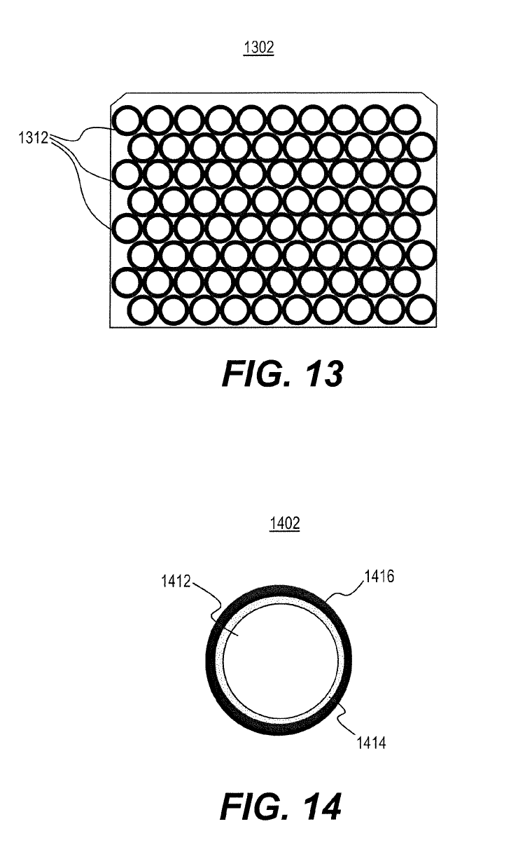

Waveguide-like arrays may comprise, for example, fused fiber optic faceplates. Fused fiber optic faceplates are commercially available devices used to provide 1 to 1 image transfer for applications such as CCD coupling. FIG. 13 shows an embodiment of a fiber optic faceplate 1302 which comprises a plurality of optical fibers 1312. The acceptance angle of fiber optic faceplate 1302 is dependent on the acceptance angle of the individual fibers 1312 that make up faceplate 1302. The limited angular acceptance of these faceplates 1302 makes them useful for recording/polytopic angular filtering of holograms. But some fiber optic mosaics may have the undesired characteristic of leaking rejected light from one fiber cladding into the core of an adjacent fiber. This problem, if it exists, may be corrected by applying a light-absorbing outer layer to the outside of the fibers, as illustrated in FIG. 14. In FIG. 14, each optical fiber 1402 includes a core 1412, a cladding 1414 surrounding core 1412 and an outer absorption layer 1416 surrounding cladding 1414. In one embodiment, core 1412 may be 1 micron in diameter. Multi-mode waveguides (i.e., larger diameters when compared to the wavelength of the light) and single mode waveguides (i.e., smaller diameters when compared to wavelength of the light) may be used but the diameter of the waveguide and the wavelength determine the acceptance angle of the waveguide (the pass-band of the filter). By placing these waveguides at the image plane (e.g., at or near the SLM and camera planes), these waveguides function like an angular filter.

The desired acceptance angle of the fiber may be determined by the total internal reflection angle between the fiber core and cladding. This angle is dependent on the index difference between the core index and cladding index. A desired acceptance angle of about ±2 degrees may be achieved by doping the fiber exterior such that the index of refraction thereof is just slightly lower (0.999) than the index of refraction of the fiber core. Alternatively, the light-absorbing outer layer may be applied directly in the place of the doped cladding and the thickness of the faceplate may be used to geometrically limit the view angle of the camera. Once a fiber boule has been fused together, thin sheets may then be sliced from the boule, polished and applied in close proximity to a camera's surface. By keeping the size of the fibers smaller than the pixel pitch, each pixel may be guaranteed illumination by multiple fibers without meticulous alignment.

Other types of optical waveguides may also be used which guide waves by any of several distinct mechanisms, including photonic-crystal fibers (which provide resonance structures having an angular passband). Waveguides in the form of a hollow tube with a highly reflective inner surface may also be used as light pipes for illumination applications. The inner surfaces of the hollow tubes may be polished metal, may be covered with a multilayer film that guides light by Bragg reflection (this is a special case of a photonic-crystal fiber), etc.

Embodiments of the non-FT plane angular filtering systems of the present invention may be used with monocular holographic data storage systems such as the systems described in U.S. patent application Ser. No. 11/840,410, entitled “Monocular Holographic Data Storage System Architecture,” to Curtis et al., filed Aug. 17, 2007, the entire disclosure and contents of which is herein incorporated by reference. The monocular architecture of the Curtis et al. application uses polytopic multiplexing which may require a recording filter and a polytopic filter. Because readout is achieved by phase conjugation, these filters may be the same if in or on the objective lens or at one of the SLM and camera if done at an image plane. For example, the objective lenses used in such a monocular architecture (i.e., the lens closest to the holographic storage medium) may have a curved filter plane designed into it, and may be used for recording and/or reading holographic data.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A holographic storage system or device comprising:
one or more of:
a data beam source for generating a data beam or
a recovered beam source for generating a recovered beam comprising holographic data recorded in a holographic storage medium;
a non-Fourier Transform plane angular filter for carrying out on or more of:
angular filtering of the data beam prior to recording holographic data in a holographic storage medium or
angular filtering of the recovered beam prior to detecting the recovered holographic data by a detector;
wherein the non-Fourier Transform plane angular filter comprises a macrotube array, an etalon, a multi-layer thin film interference coating on a curved surface, a lenslet array device, a waveguide-like array, or a combination thereof.

2. The system or device of claim 1, wherein the non-Fourier Transform plane angular filter comprises a macrotube array.

3. The system or device of claim 2, wherein the macrotube array comprises macrotubes etched in silicon.

4. The system or device of claim 1, wherein the non-Fourier Transform plane angular filter comprises an etalon at the image plane.

5. The system or device of claim 1, wherein the non-Fourier Transform plane angular filter comprises a multi-layer thin film interference coating on a curved surface.

6. The system or device of claim 5, wherein the interference coating comprises from about 1 to about 40 layers of a dielectric material.

7. The system or device of claim 5, wherein the interference coating includes a patterned surface.

8. The system or device of claim 6, wherein the interference coating is on the curved surface of a lens.

9. The system or device of claim 8, wherein the lens is an objective lens.

10. The system or device of claim 1, wherein the non-Fourier Transform plane angular filter comprises a lenslet array device.

11. The system or device of claim 10, wherein the lenslet array device comprises a lenslet array imaging assembly wherein each lenslet of the lenslet array focuses incident rays: (a) onto a light-absorptive coating surrounding an array of apertures, wherein incident rays having a small enough angle of incidence pass through the apertures, and wherein incident rays having an angle of incidence which is too large are filtered out by the absorptive coating; or (b) through incident ray focusing tubes having spaced apart light-absorbing walls, wherein the tubes are long enough so that incident rays having a small enough angle of incidence pass through the tubes, while incident rays having an angle of incidence which is too large are filtered out by the tubes.

12. The system or device of claim 1, wherein the non-Fourier Transform plane angular filter comprises a waveguide-like array.

13. The system or device of claim 12, wherein the waveguide-like array comprises a fiber optic faceplate comprising a plurality of optical fibers, each of the optical fibers having a light-absorbing outer layer.

14. A method for recording holographic data comprising the following the steps:
(a) providing a data beam; and
(b) passing the data beam through a non-Fourier Transform plane angular filter to carry out angular filtering of the data beam prior to recording holographic data in a holographic storage medium, wherein the non-Fourier Transform plane angular filter comprises: a macrotube array, an etalon, a multi-layer thin film interference coating on a curved surface, a lenslet array device, a waveguide-like array, or a combination thereof.

15. The method of claim 14, wherein the non-Fourier Transform plane angular filter is located in the image space, and wherein the non-Fourier Transform plane angular filter limits the angular bandwidth emitted by a pixel element of a spatial light modulator.

16. The method of claim 14, which comprises the further step of multiplexing the holographic data into the holographic storage medium after angular filtering of the data beam during step (b).

17. The method of claim 14, wherein the holographic data is multiplexed by angle multiplexing, polytopic multiplexing, or angle-polytopic multiplexing.

18. A method for recovering holographic data comprising the following steps:
(a) providing a recovered beam comprising recovered holographic data; and
(b) passing the recovered beam through a non-Fourier Transform plane angular filter to carry out angular filtering of the recovered beam prior to detecting the recovered holographic data by a detector, wherein the non-Fourier Transform plane angular filter comprises: a macrotube array, an etalon, a multi-layer thin film interference coating on a curved surface, a lenslet array device, a waveguide-like array or a combination thereof.

19. The method of claim 18, wherein the non-Fourier Transform plane angular filter is located in the image space, and wherein the non-Fourier Transform plane angular filter limits the angular bandwidth accepted into a pixel element of a detector.

20. The method of claim 18, wherein the recovered beam of step (a) is generated by phase conjugate reconstruction.

21. The method of claim 18, wherein the recovered beam of step (a) is generated by recovering multiplexed holographic data from the holographic storage medium.
